(19) United States
(12) Patent Application Publication
(10) Pub. No.: US 2017/0105448 A1
(43) Pub. Date: Apr. 20, 2017

(54) Liquefied Gas Powered Cigarette

(71) Applicant: Peter Scarpulla, Garfield, NJ (US)

(72) Inventor: Peter Scarpulla, Garfield, NJ (US)

(21) Appl. No.: 14/918,520

(22) Filed: Oct. 20, 2015

(51) Int. Cl. A24F 47/00; F16K 31/12; F16K 15/14; B65D 41/20

(52) U.S. Cl. CPC A24F 47/002; B65D 41/20; F16K 31/12; F16K 15/144

(57) ABSTRACT

The present invention provides a personal vaporizer apparatus having a holding cartridge for storing a pressurized mixture. The holding cartridge contains a bottom end and an outlet end. The bottom end may contain a refill valve. The outlet end gets threaded unto a pressure regulating mechanism having a first valve. The pressurized mixture exits through the valve into a discharge channel, where the mixture exits through the mouthpiece in form of vapor. The holding cartridge may be replaced, with the rest of the device remaining intact. The pressurized mixture may be introduced into the external contain directly. The entire operation of the personal vaporizer apparatus is mechanical requiring no electronic power source to fuel operation.

### FIELD OF THE INVENTION

The present invention relates to a personal control vapor emitter device for expelling pressurized liquids in gaseous form or in form of fine particle vapor, or aerosol. In particular, the invention relates to a puffer or cigarette like device for discharging externally stored liquid cocktails of a controlled substance into a user's oral cavity.

### BACKGROUND OF THE INVENTION

The present invention aims to provide an alternative to electronic cigarette, as well as traditional tobacco burning cigarettes. More importantly, the device embodied by the present invention is another step forward in the drive to eliminate widespread smoking of traditional cigarettes. Some research has shown that non-tobacco burning cigarettes carry significantly lower health concerns than the traditional cigarettes.

Electronic cigarettes have been around since 2003. Their use has been gradually increasing, driven both by those trying to switch from traditional tobacco cigarettes and by first time smokers, attracted by the social allure of group smoking and modernity factor of the device. As the electronic cigarette gains in popularity, the variety of different puffing solutions, including the healthy nicotine and tobacco free alternatives are emerging in greater numbers. While the existence of puff market has slightly reduced operating costs of existing puffing devices, the actual price of the electronic device itself will remain quite high, especially since users will need to replace spent batteries to continue using such a device.

Another downside of an electronic cigarette is that it requires an external source of power to extract the puffing cocktail. Until now, the external source of power has been the lithium ion battery, which has been especially manufactured to fit snugly into the limited dimensions of the electronic cigarette device. A user of such device must not only worry about puffer refills, but must also ensure that the device's battery contains sufficient charge to power the next smoking session. Since these are not standard batteries used for larger electronic devices, the user's ability to enjoy his device may be frustrated by extended periods of time until the user is able to secure replacement batteries in specialty stores or by mail order.

On the contrary, the present invention is designed to eliminate the need of battery power. User can enjoy the device as long as the pressurized solution has not been completely spent. The absence of additional electronic parts and cheaper composite materials required to manufacture the device subject to the present invention will definitely reduce costs and availability of such devices. Easy access and low maintenance usage is likely to divert further smokers from conventional cigarettes, thereby improving the health of the overall populace. Therefore the only thing that separates a user from getting a few puffs, is only the possible insufficient level of the puffing solution within the device.

Vapor emitting devices have been known in the industry, but generally suffer from shortcomings as described above.

### BRIEF DESCRIPTION OF THE RELATED ART

U.S. Pat. No. 3,758,777 discloses a High vacuum ion source for use with a mass spectro-meter to analyze solid substances. A thermally conductive body having the substance to be analyzed supported on a surface thereof is disposed in the ionization chamber with the substance supporting surface facing the ionization region of the chamber. A heat source, such as an electron emitting device, is directed toward the opposite surface of the body to heat the body and cause the substance to vaporize. The heating of the body in turn heats the chamber surfaces to prevent condensation of the vaporized substance. The vaporized substance can be ionized by particle bombardment or field emission. The body may take the form of a flat plate or a cylindrical or other box-like structure.

U.S. Pat. No. 8,714,161 relates to an electronic cigarette with solid tobacco substance, which includes a shell with a mouthpiece at one end; a reservoir in the shell for storing tobacco substance; an atomizing device in the shell having an atomizing cup, an atomizer in the atomizing cup for vaporizing tobacco substance; and an aerosol passage connecting the mouthpiece with the atomizing cup; and a guiding unit for drawing tobacco substance from the reservoir to the atomizing device. The atomizing cup is accommodated in the reservoir, the guiding unit penetrates sidewall of the atomizing cup and extends in the reservoir, and solid tobacco substance encases the atomizing cup and guiding unit therein. The present invention solves the problem of solid tobacco substance melting slowly and uneasy assembly of the cigarette; and obtains to improve the melting efficiency of solid tobacco substance and facilitate the assembly.

Various implements are known in the art, but fail to address all of the problems solved by the invention described herein. One embodiment of this invention is illustrated in the accompanying drawings and will be described in more detail herein below.

### SUMMARY OF THE INVENTION

The present invention provides a personal vaporizer apparatus having a holding cartridge for storing a pressurized mixture. The holding cartridge contains a bottom end and an outlet end. The bottom end may contain a refill valve. The outlet end gets threaded unto a pressure regulating mechanism having a first valve. The pressurized mixture exits through the valve into a discharge channel, where the mixture exits through the mouthpiece in form of vapor.

It is an object of present invention to provide a vaporizer apparatus having an inhaling cocktail.

It is an object of the present invention to provide a vaporizing apparatus that is cheap to operate.

It is another object of the present invention to provide a vaporizer apparatus that does not require battery power to operate.

Yet another object of the present invention is to provide a vaporizer apparatus that is easy to use.

Yet another object of the present invention is to provide a vaporizer apparatus that is reusable.

Still another object of the present invention is to provide a vaporizer apparatus that is able to accommodate a refillable cartridge.

It is still another object of the present invention to provide an apparatus capable of using plastic holding canisters for pressurized inhaling cocktail.

### BRIEF DESCRIPTION OF THE DRAWINGS

FIGS. 1A, 1B are a demonstration of a cross sectional view of the preferred embodiment of the present invention.

FIGS. 2A-2C are various views of the assembled personal vaporizer apparatus.

FIGS. 3A, 3B are exploded diagrams of the preferred embodiment of the present invention.

FIGS. 4A, 4B are exploded diagrams of the preferred embodiment of the present invention.

FIGS. 5A, 5B are cross sectional diagrams of an alternative embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Turning now descriptively to the drawings, in which similar reference characters denote similar elements throughout the several views, the figures illustrate a personal vaporizer device 10. The personal vaporizer device 10 may be shaped as a conventional electronic cigarette device as shown, or may be embodied in a less conventional fashion, such as a pipe device of various sorts. The shown embodiment is preferred since it is more compatible with conventional CO² cartridges known in the art and used for anything from tire inflation devices to soda aerators. However, other adaptations may accommodate the same conventional CO2 canisters in embodiments of personal vaporizer device 10 that does not resemble a conventional or electronic cigarette.

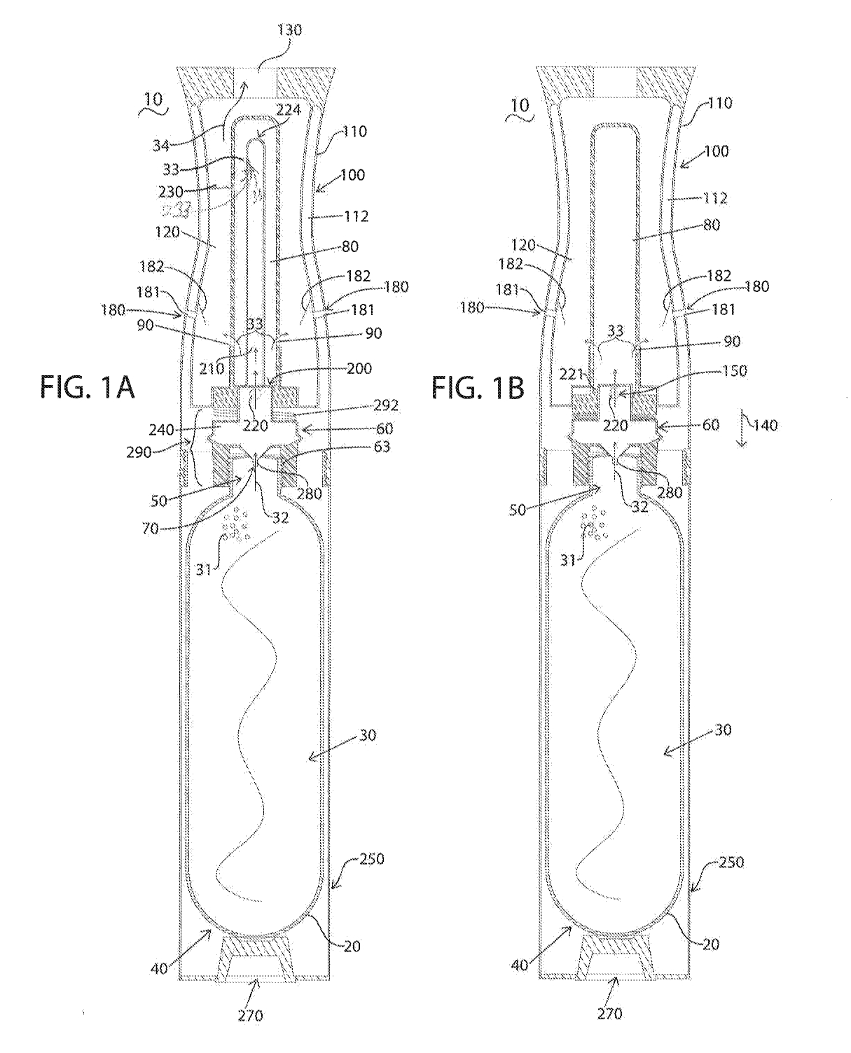

FIGS. 1A and 1B are cross section views of the preferred embodiment. Shown are personal vaporizer apparatus 10, a holding cartridge 20, a pressurized mixture 30, a bottom end 40, an outlet end 50, a pressure regulating mechanism 60, a first valve 70, at least one discharge channel 80, at least one opening 90, a mouthpiece 100, a textured outer surface 110, an external fill chamber 120, an exit opening 130, an linear force 140, a discharge position 150, a closed position 160, at least one variably opening air intake valve 180, an acute angle 190, a second valve 200, a fill chamber 210, said second valve opening 220, a pressure regulator 230, an internal fill chamber 240, an external container 250, a sealing membrane 260, a refill valve 270, a puncture pin 280, and an activator 290.

A pressurized mixture is loaded into the holding cartridge 20. The holding cartridge 20 may be made of metal or of a reinforced composite material such as reinforced plastic, or metal composite or a pressure resistant polymer such as but not limited to a geopolymer, or a silicone. A wood based or a cellulose fiber based material may also be used. Material and shape of the holding cartridge 20 will be generally dictated by the pressure of the stored payload or the pressurized mixture 30. The holding cartridge 20 may be a substantially elliptical, bottle like shape, which may be desirable for holding highly pressurized mixtures 30. However other shapes are possible, such as spherical, cylindrical, rectangular, oblong, quadrilateral or rhombic, or have a combination of shapes either grouped together or one flowing into another.

The pressurized mixture 30 in the holding cartridge 20 is a pressurized liquid. The liquid is interspersed with a pressurized gas propellant such as propylene glycol, butane, nitrous oxide or carbon dioxide, or any other non-toxic or low-toxic gas known in the industry for its propellant qualities. The gas will be mixed together with a pressurized liquefied solution which may or may not include tobacco or other stimulants, medicine, water or liquid fragrances and flavored liquids. The holding cartridge 20 preferably tolerates between 12 pounds per square inch (PSI) to 40 PSI, depending on the size and shape of the holding cartridge 20.

FIG. 1A demonstrates the flow of the pressurized mixture 30, which originates as payload 31 inside the holding cartridge 20. As more payload 31 is expelled, additional amounts of the liquefied pressurized mixture 30 evaporates into the outlet end of the holding cartridge, until the pressure inside the holding cartridge is reestablished. The payload 32 then flows through the first valve 70 into the internal fill chamber 240 as shown by arrow 32. Then, once the first valve 70 closes, the second valve opening 220 opens forcing the pressurized mixture 30 through the second valve opening 220 of the second valve 200 and into the fill chamber 210. Then, as shown in with arrow 33, the payload 31 continues through the regulator 230. The regular 230 is a substantially tubular chamber having a valve 233, which may be a pressure sensitive swing valve. If a pressure sensitive swing value is used for the valve 233, then if payload pressure within the chamber 230 reaches a certain predetermined maximum, the regulator 230 will swing out into the discharge chamber 80. The regulator 230 may be opened by the linear force 140, by the volume of gas inside the fill chamber 210, or through action of an external agitator (not shown). The pressurized mixture 31 then flows into the discharge cylinder 80 and then through the openings 90 into the external fill chamber 120 and then out of the external fill chamber 120 toward the exit opening 130, as shown by arrow 34. Throughout the flow of the payload 31, the steps are designed to lower the ultimate PSI pressure of the pressurized mixture 30 that manifests itself at the exit opening 130 from approximately 12-25 psi to two approximately 5 PSI or lower. The essential concept is to use a pressurized solution which turns to gas at room temperature without the use of energy consuming heat. The solution is therefore to release the gas, but slow it in stages until it is fit for inhaling. This can be accomplished through any combination of chambers, gates or valves.

The air intake valve 180 in the mouthpiece 100 that functions to direct the payload exiting through the openings 90, as shown with directional arrows 32, in the direction of the exit opening 130. The intake valve 180 creates a stream of air that channels the pressurized mixture 30 towards the exit opening 130. An air intake valve 180 contains a flap 182 that is biased to adhere to the sidewall 112 and cover an opening 181 through the sidewall 112. The flap 182 is preferably manufactured out of soft and flexible material, such as thin rubber, plastic, or silicone, and would flex in the direction away from the sidewall 112, as demonstrated in FIG. 1A, to allow admittance of the air through the opening 181 into the external fill chamber 120. The flap 182 flexes away from the sidewall 112 when the user takes a drag, sucks or inhales air through exit opening 130. This creates a suction force that causes the flaps 182 to flex away from the sidewall 112. The desired flap operation may also be induced by the external linear force 140, when the sidewall flexes 112 thereby disturbing the perfectly flush association of the flap 182 with the sidewall 112.

The mouthpiece 100 may contain at least one or a plurality of such air intake valves 180, which may be disposed anywhere along the sidewall 112. The desired diameter of an opening 181 is between one and four millimeters and depends on the desired strength and dilution levels of the desired payload reaching the exit opening 130. Similarly, there may be at least one or a plurality of openings 90 with a diameter of between one and three millimeters and located anywhere along the length of the discharge channel 80. The diameters and sizes found in this application are merely preferences and are not intended to limit the number and scope of variations designed to fulfill functional or aesthetic purposes.

FIG. 1B illustrates the same components except that pressure regulator 60 releases the pressurized mixture 30 through the second valve opening 220 directly into the discharge channel 80 without entering the fill chamber 210. The configuration not having the fill chamber 210 may be more desirable if the pressurized mixture 30 contains payload 31 at a lower PSI than the payload in FIG. 1A. Alternatively the configuration in FIG. 1B is more desirable if the user wants the payload 31 being expelled through the openings 90 at a higher PSI levels of approximately 10 PSI and lower.

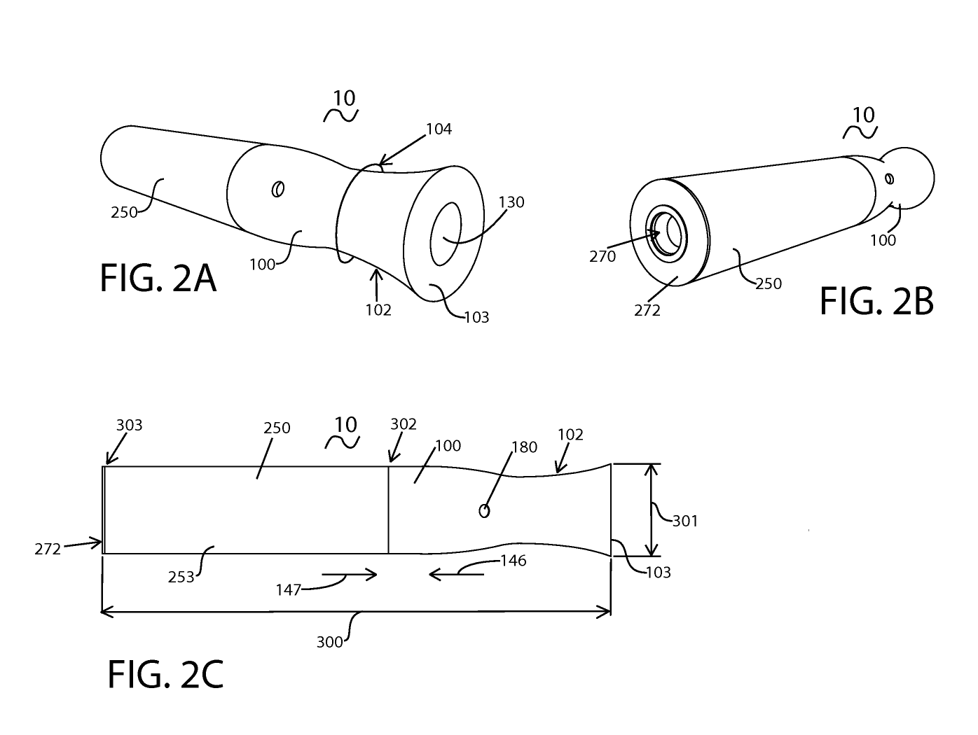

FIGS. 1A and 1B demonstrate the external force that causes payload ejection from the holding cartridge 20. In FIG. 1A, the sidewalls 112 are perfectly flush with the sidewall 251 of the external container 250. Furthermore the spring 292 is not compressed, meaning that all valves, such as the first valve 70, or the second valve 200 or the pressure regulator 230 are in closed position. During normal usage, the mouthpiece 100 is inserted into a user's mouth and held between lips. The mouthpiece 100 is coated with textured surface 110, to make the sidewall 112 of the mouthpiece 100 more appealing and less jarring upon touch. A user then grasps the external container 250 and pulls it linearly toward the mouthpiece 100. Alternatively, a user may push said mouthpiece 100 against the external container 250, thus inducing the linear force 149 that compresses the personal vaporizer apparatus 10, producing the bulge 148 as seen in FIG. 2B. The initial pressure causes first valve to open and internal fill chamber to fill with payload 31. Then as the pressure continues the first valve 70 closes and the second valve 200 opens, ejecting the payload 31 into the fill chamber 210 or directly into the discharge channel 80. The pressure regulating mechanism 60 is only one embodiment of pressure regulating mechanism that may accomplish the task of releasing the pressurized mixture 30, while lowering the PSI of the mixture being released. However other embodiments and configurations may achieve the same results, and this description does include those embodiments, which are known in the art, but are not disclosed herein.

The preferred overall dimensions of the personal vaporizer apparatus 10 are approximately between three and five inches in length 300 and between ¾ and ⅛ of an inch in a diameter or width 301. These are preferred dimensions and alternative dimensions may be possible. As demonstrated in FIGS. 2A-2C, the overall shape of the personal vaporizer apparatus 10 is cylindrical with the width 301 being substantially uniform throughout the length 301. Alternatively the corpus of the personal vaporizer apparatus 10 may be in a shape of a pipe, spherical, cubic or rectangular. The external container 250 may have substantially the same width 301 throughout or may have a narrower width at the connecting end 302, thus appearing trapezoidal to the onlooker, or at the terminal end 303, thus appearing conical to the onlooker.

The mouthpiece 100 preferably contains a neck indentation 102 as shown, throughout the circumference of the circumference 104. The neck indentation 102 may be desired to provide additional comfort to the lips of a user. Alternatively the neck indentation 102 may appear just on two sides of the mouthpiece 100, to further simulate lips clamping down. A user, after inserting the oral end 103 of the personal vaporizer apparatus 10 into mouth, would place lips onto indentation 102. Furthermore, one of the activating ways is to compress the external container 250 and the mouthpiece 100 together (reference lines 147). In so doing, a user would be simultaneously pressing with lips in the direction 146, and, while holding onto the external container 250, would be pulling in the direction 147. The neck indentation 102 would thus provide a better grip forming surface for lips. Similarly, the sidewall 253 of the storage container 250 may contain grip lines or indentations on the surface of the sidewall 253 (not shown). Also shown in FIGS. 2A-2C is the refill valve 270 and a cover for the refill valve 272. The cover for the refill valve prevents the internal contents of the external container 250 from falling out, spilling or leaking out during operation of the apparatus 10. The mouthpiece 100 and the external container 250 may be made of same or different materials.

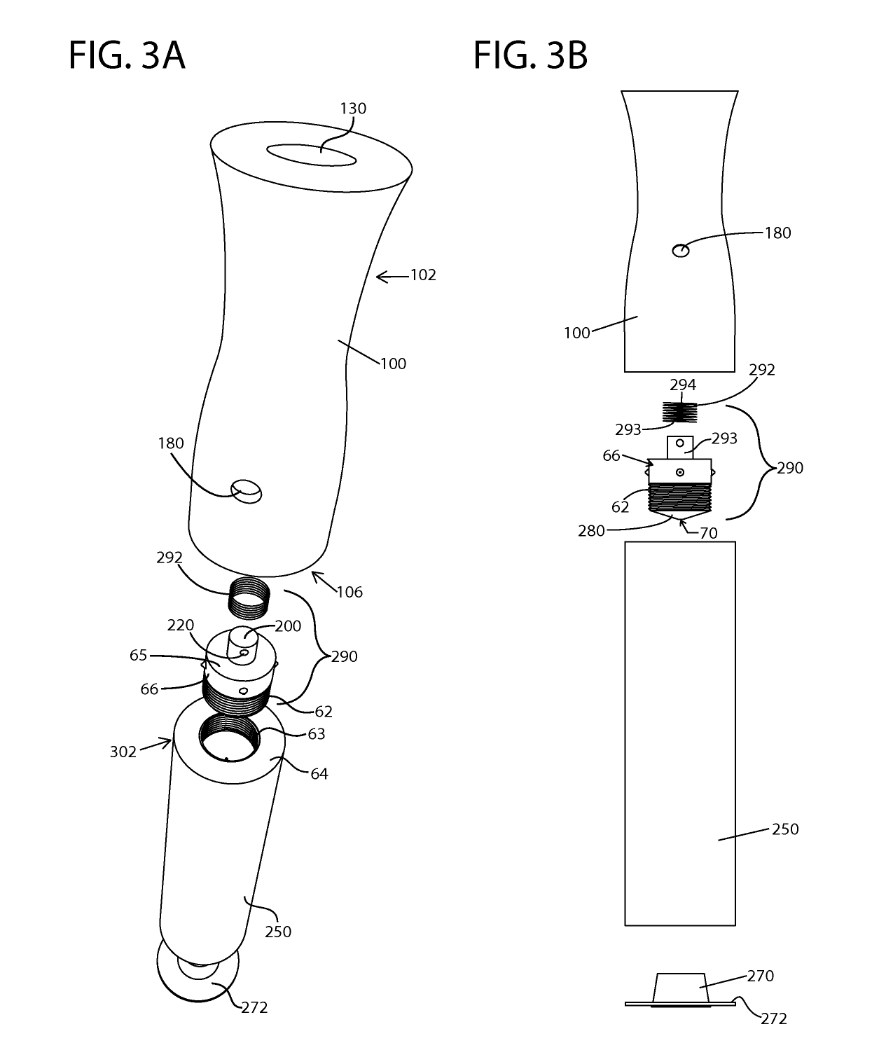

FIGS. 3A and 3B present an exploded diagram of the present invention. Shown are personal vaporizer apparatus 10, a pressure regulating mechanism 60, a mouthpiece 100, an exit opening 130, at least one variably opening air intake valve 180, an external container 250, a refill valve 270, a puncture pin 280, and an activator 290. Shown are the external dimensions of the pressure regulating mechanism 60. The second valve opening 200 is shown in the side of the second valve 200. Shown is actually the external casing of the second valve 200. The thread 62 corresponds to the thread 63 for an airtight fit between the pressure regulating mechanism 60 and the external container 250. In the embodiment shown, the external container 250 actually stores the pressurized mixture 30 and there is no holding cartridge 20.

The regulating mechanism 60 is mounted within the mouthpiece 100, at the connection end 106. The sidewall 66 is lodged securely within the face 105 of the mouthpiece 100. The spring 292 and the pressure regulating mechanism 60 combine to form an activator 290. The first end 294 of the spring 292 is mounted against the bottom end of the discharge channel 80 (FIG. 1A), while the second end 293 rests on top of flange 65. These are support surfaces that act as resisting surfaces when the spring 292 is compressed as a result of the linear forces 149. The terminal flange 64 at the connector end 302 may or may not form an airtight seal with the connection end 106 since the pressure regulating mechanism 60 serves as a hermetic conduit of the pressurized mixture 30 from the external container 250 into the mouthpiece 100.

The variable size opening 180 varies in diameter depending on an embodiment. It is also varies as far as to what extent the opening is open to the air. The last factor is determinative on the drag or suction force that a user applies at the exit opening 130 while inhaling.

The refill valve 270 forms a hermetic seal with the external container 250. In the embodiment shown, the refill valve 270 may be utilized to reintroduce the pressurized mixture 30 without actually removing the refill valve cover 272.

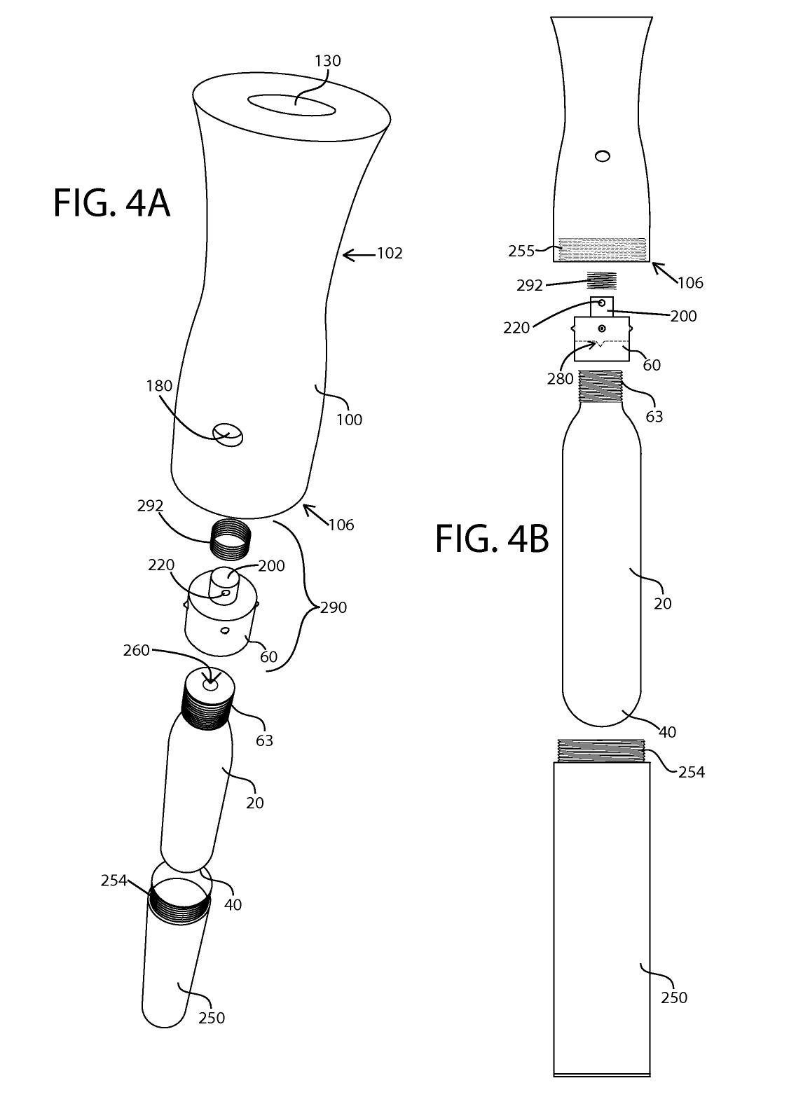

FIGS. 4A and 4B demonstrate a rechargeable embodiment of the present invention. Shown in this invention is the holding cartridge 20. The holding cartridge 20 may be manufactured from a variety of materials, such as, but not limited to metals, plastics, resins, wood, or ceramics. The spherical shape of the holding cartridge 20, as well as external or internal reinforcing structural element provide ample strength to contain the pressurized mixture 30. The pressure regulating mechanism 60 is now threaded unto the thread 63 until an airtight coupling is achieved. The threads 63 and the thread on the pressure regulating mechanism 60 may contain rubberized material or a resinous or polymeric coating to better seal the gaps. As the pressure regulating mechanism 60 is threaded onto the threads 63, the puncture pin presses on top of the membrane 260, eventually puncturing it. The membrane seals itself around the puncture pin 280. The first valve 70 may be disposed on the puncture pin 280 or may be further up on the main corpus of the regulating mechanism 60.

The external container 250 in the embodiment shown in FIGS. 4A and 4B may be threaded or snapped onto the female thread 255 or snap receiver in the connecting end 106. A magnetized or a frictional coupling may be utilized as well. In order to replace or recharge the holding cartridge 20, a user would need to remove the external container 250 from the female thread 255 and then detach the holding cartridge 20 from the regulating mechanism 60. Some of the buildup and trapped payload may escape during the process of disassembly.

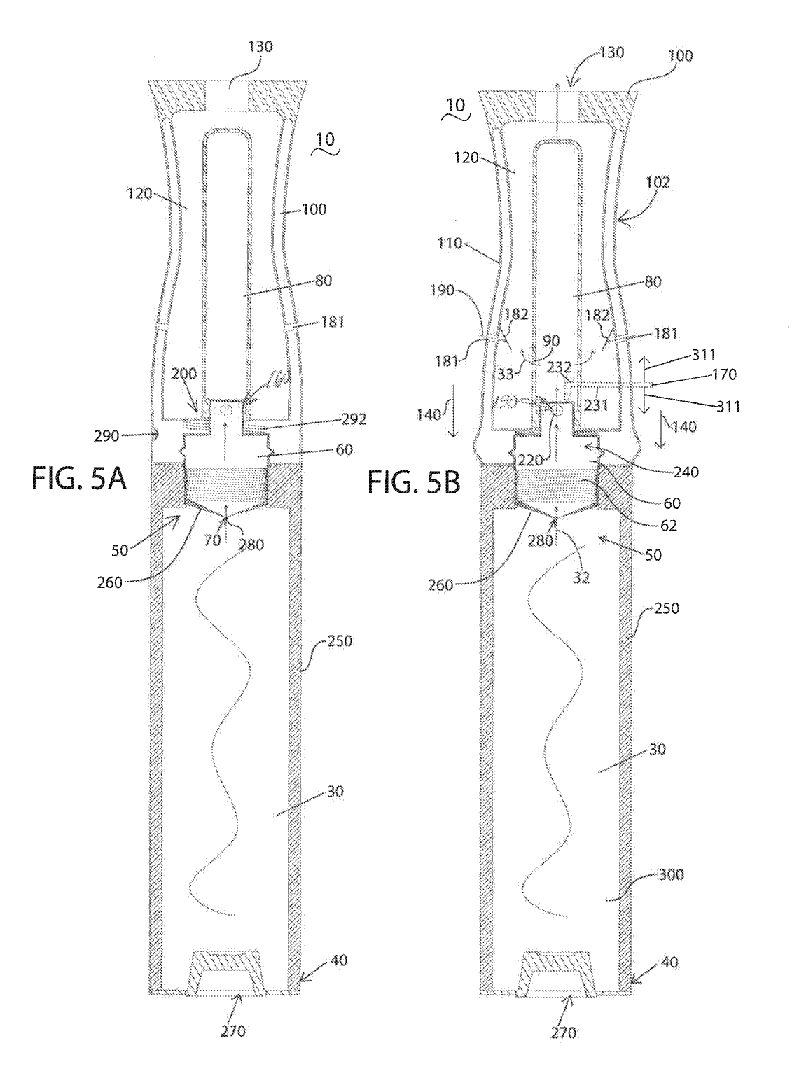

FIGS. 5A and 5B demonstrate an alternative embodiment of the present invention. Shown are personal vaporizer apparatus 10, a pressurized mixture 30, a bottom end 40, an outlet end 50, a pressure regulating mechanism 60, a first valve 70, at least one discharge channel 80, at least one opening of said discharge 90, a mouthpiece 100, a textured outer surface 110, an external fill chamber 120, an exit opening 130, an external force 140, a discharge position 150, a closed position 160, an external actuator 170, at least one variably opening air intake valve 180, an acute angle 190, a second valve 200, a valve opening 220, an internal fill chamber 240, an external container 250, a sealing membrane 260, a refill valve 270, a puncture pin 280, an activator 290, an internal cavity 300. The embodiment shown does not contain a holding cartridge 20, therefore the pressurized mixture is held within the storage container 250. To ensure perfectly hermetic coupling a sealing membrane 260 surrounds the threaded coupling surface of the pressure regulating mechanism 60.

Shown also is the external actuator 170, which is an external device having an arm 231 that extends through the sidewall 112 of the mouthpiece 100 and into the discharge channel 80. The arm 231 connects to the trigger arm 232 which then connects to the second valve 200. The arm 231 may move radially in a direction perpendicular to the linear force 140 or in substantially straight line in a reciprocal lateral motion 311 as shown, which may be in addition to or as an alternative to the linear force 140. The external actuator 170 that is external to the mouthpiece 100 is shown in this embodiment, but may be just as effectively practiced with embodiments shown in other figs demonstrated in this invention.

To create a reusable device from figs shown in FIGS. 5B and 5B the refill valve 270 must be resealing after refills. Alternatively, the valve 270 may be a fill once and seal type, where a user will replace the storage containers 250, keeping the mouthpiece 100 and the pressure regulating mechanism as the replaceable components of the present invention.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A personal vaporizer apparatus comprising, a holding cartridge capable of containing a pressurized mixture; wherein said holding cartridge contains a bottom end and an outlet end; said outlet end removably engaged to a pressure regulating mechanism having a first valve; said holding cartridge releasing said pressurized mixture at a desired rate through said first valve; wherein said first valve directing said pressurized mixture into at least one discharge channel; and wherein at least one opening of said discharge channel expelling said pressurized mixture.

2. The personal vaporizer apparatus of claim 1, further comprising a mouthpiece, said mouthpiece having a textured outer surface an external fill chamber and an exit opening; wherein said external fill chamber accepting said pressurized mixture being expelled from said at least one opening and directing said pressurized mixture to said exit opening.

3. The personal vaporizer apparatus of claim 1, wherein said discharge channel is acting under an external force; said external force exerting a linear force is capable of placing said first valve into a discharge position; and wherein said first valve returning to a closed position once said linear force is removed

4. The personal vaporizer apparatus of claim 3, said linear force is being exerted by said mouthpiece.

5. The personal vaporizer apparatus of claim 3; further comprising an external actuator, wherein said external actuator is capable of exerting said linear force; and wherein said external actuator is evident on said textured surface.

6. The personal vaporizer apparatus of claim 2, wherein said mouth piece further comprises at least one variably opening air intake valve, wherein said at least one variably opening air intake valve being open during discharge of said pressurized mixture from said at least opening into said external fill chamber.

7. The personal vaporizer apparatus of claim 7, wherein said at least one air intake valve is disposed at an acute angle with respect to said at least one opening.

8. The personal vaporizer apparatus of claim 1, further comprising a second valve and a fill chamber, said second valve opening

9. The personal vaporizer apparatus of claim 1, further comprising a pressure regulator, said regulator capable of transmitting pressure setting to a second valve; an internal fill chamber disposed between said second valve and said first valve; said second valve opening into said outlet end and filling said internal fill chamber until a desired pressure is reached; wherein said first valve is set into a discharge position.

10. The personal vaporizer apparatus of claim 3, further comprising a pressure regulator, said regulator capable of transmitting pressure setting to a second valve; an internal fill chamber disposed between said second valve and said first valve; said second valve opening into said outlet end and filling said internal fill chamber until a desired pressure is reached; wherein said first valve is set into a discharge position.

11. The personal vaporizer apparatus of claim 1, further comprising an external container, said external container removably encapsulating said holding cartridge, wherein said external container fastens to said pressure regulating mechanism.

12. The personal vaporizer apparatus of claim 1, wherein said outlet end further comprises a sealing membrane, said sealing membrane being punctured during said engagement between said holding container and said pressure regulating mechanism.

13. The personal vaporizer apparatus of claim 1, wherein said holding cartridge further comprises a refill valve.

14. The personal vaporizer apparatus of claim 12, wherein said pressure regulating mechanism further comprises a puncture pin, said puncture pin capable of penetrating a sealing membrane on said holding container; and said pin being activated by said external actuator.

15. The personal vaporizer apparatus of claim 10, wherein said pressure regulating mechanism further comprises a puncture pin, said puncture pin capable of penetrating a sealing membrane on said holding container; and said pin being activated by an activator.

16. The personal vaporizer apparatus of claim 2, wherein said holding container, said pressure regulating mechanism, said mouthpiece and an external container are assembled linearly; wherein said external container removably encapsulating said holding cartridge, wherein said external container fastens to said pressure regulating mechanism.

17. The personal vaporizer apparatus of claim 1, wherein said holding container is made of a group of materials comprising a composite material, plastics, metals, resins or ceramics.

18. The personal vaporizer apparatus of claim 1, wherein said pressure regulating mechanism further comprises an internal cavity, said internal cavity being filled with said pressurized mixture by opening said pressure regulating valve; wherein said internal cavity being variably sealed from discharge channel by a discharging valve; wherein said pressure regulating valve or said discharging valve are controlled by an external actuator; and wherein said pressure regulating mechanism is reducing an expelling force from said holding container to between five and twenty five PSI.

19. The personal vaporizer apparatus of claim 10, wherein said pressure regulating mechanism is reducing an expelling force from said holding container to between five and twenty five PSI.

20. The personal vaporizer apparatus of claim 1, wherein said pressure regulating mechanism is reducing an expelling force from said holding container to between five and twenty five PSI.
